(19) United States
(12) Patent Application Publication
(10) Pub. No.: US 2013/0115910 A1
(43) Pub. Date: May 9, 2013

(54) Systems and Methods of Intelligent Find Me Follow Me Services

(71) Applicants: Robert Clark Whitten, Kennesaw, GA (US); Brandon Hall Goode, Canton, GA (US); Philip Brent Foreman, Gadsden, AL (US)

(72) Inventors: Robert Clark Whitten, Kennesaw, GA (US); Brandon Hall Goode, Canton, GA (US); Philip Brent Foreman, Gadsden, AL (US)

(73) Assignee: COX COMMUNICATIONS, INC., Atlanta, GA (US)

(21) Appl. No.: 13/288,688

(22) Filed: Nov. 3, 2011

(51) Int. Cl. H04M 11/00

(52) U.S. Cl. 455/405

(57) ABSTRACT

An intelligent Find Me, Follow Me (FM/FM) service includes forming, processing, and ordering a list of end points which may be used for searching for a subscriber in a telecommunication system. A typical problem with previous FM/FM services is that the “follow me” portion does not track the usage of a device in order to make the decision on the order of endpoint contact. Example embodiments of the disclosed systems and methods of intelligent FM/FM services include a method of tracking endpoint usage to make an intelligent ordering of the devices in an FM/FM contact group.

### TECHNICAL FIELD

The present disclosure is generally related to telecommunications and, more particularly, is related to unified communications services.

### BACKGROUND

In today's world of instant communication, a caller expects to be able to instantly contact an intended called party. A called party may set up a list of numbers that the incoming call may be routed to regardless of the number that is dialed by the calling party. The calling party may dial one number, such as 678-373-4747, and the call may be routed to, for example, one of a home number, a cell number, an office number, etc. Additionally, if the call is not successfully connected to the first number on the list, a call connection may be attempted at the other numbers on the list. The routing list may be ordered. There may be a default order, or the order may be modified by the called party who owns the list. The list may be set up to route calls based on date, time of day, or other factors, for example. However, these lists are static and must be changed by the list owner. There are heretofore unaddressed needs with these previous solutions.

### SUMMARY

Example embodiments of the present disclosure provide systems of intelligent find me follow me services. Briefly described, in architecture, one example embodiment of the system, among others, can be implemented as follows: a presence server configured to track usage for a user; an application server configured to determine an endpoint contact order for a list of endpoints based on an algorithm applied to the tracked usage; and a network configured to send a communication to an endpoint on the list of endpoints in the endpoint contact order.

Embodiments of the present disclosure can also be viewed as providing methods for intelligent find me follow me services. In this regard, one embodiment of such a method, among others, can be broadly summarized by the following steps: tracking usage for a user; determining an endpoint contact order from a list of endpoints based on an algorithm applied to the tracked usage; and sending a communication intended for the user to an endpoint on the list of endpoints in the endpoint contact order.

### BRIEF DESCRIPTION OF THE DRAWINGS

FIG. 1 is a system block diagram of an example embodiment of an intelligent FM/FM system.

FIG. 2 is a system block diagram of an example embodiment of an system interface for a device in the intelligent FM/FM system of FIG. 1.

FIG. 3 is a system block diagram of an example embodiment of an application interface for the intelligent FM/FM system of FIG. 1.

FIG. 4 is a flow diagram of an example embodiment of a method of providing an intelligent FM/FM service.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

An example of a Find Me, Follow Me (FM/FM) service includes forming, processing, and ordering a list of end points which may be used for searching for a subscriber in a telecommunication system. A typical problem with previous FM/FM services is that the “follow me” portion does not track the usage of a device in order to make the decision on the order of endpoint contact. Example embodiments of the disclosed systems and methods of intelligent FM/FM services include a method of tracking endpoint usage to make an intelligent ordering of the devices in an FM/FM contact group. For instance, the disclosed intelligent FM/FM system may determine that the user answered a call or a video session or instant messaging session, etc. . . . ten minutes ago on a particular device. Then the system predicts that the user is likely to be available on that device for the next communication.

Example embodiments of the disclosed systems may use statistical data to anticipate a subsequent device beyond that particular device to which the next call should be sent if the call isn't answered on that particular device. Furthermore, example embodiments of the disclosed systems may use a time of day (TOD) and day of week (DOW) enhancement to make intelligent predictions regarding which device a user is likely to answer based on the time and/or day of the call. Alternative embodiments may obtain non-call related data, such as presence, to determine if a device should be contacted. For instance, if the user has her out of office (OOO) notification set up, sending a call to the office device would not result in a connection. Finally, device usage (call or non-call related) may also be used as criteria for selecting the order in which to send calls to the devices in the FM/FM group. For example, if a user has recently sent a text message from a device, this communication indicates that the device has a higher likelihood of being used to reach the user, thus making it higher in the priority in the FM/FM group device list. If all devices in the FM/FM group device list interact with the FM/FM service, the service will determine from the entire set of devices in the FM/FM group when the last call is received or originated from. However, it is possible that not all devices in the FM/FM group will interact with the FM/FM service.

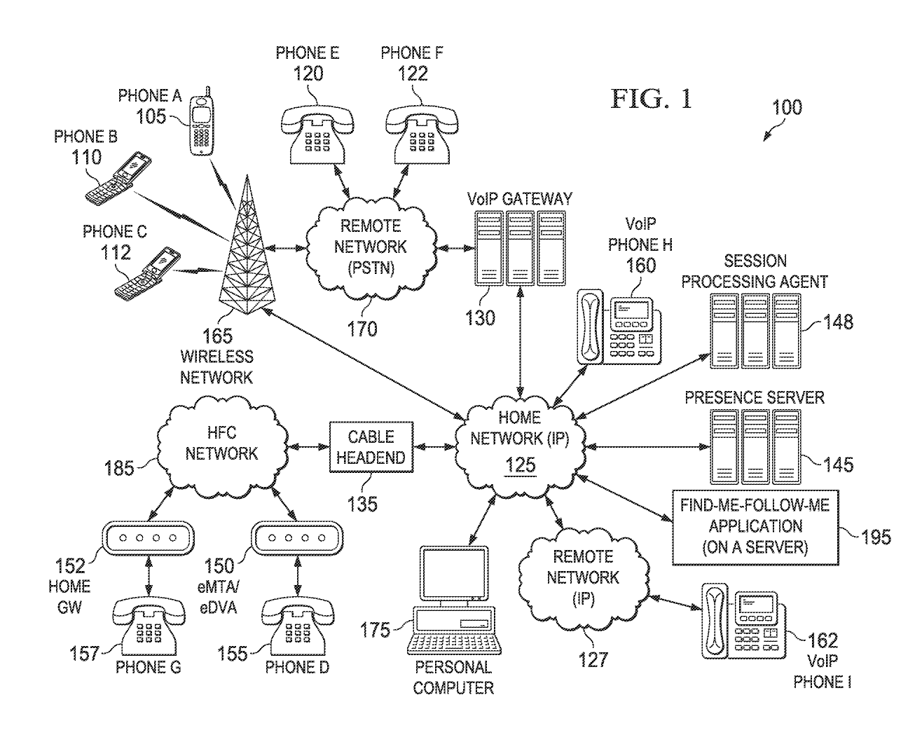

FIG. 1 provides system block diagram 100 of an example embodiment of an intelligent FM/FM service system. The FM/FM device group includes phone 105, phone 110, phone 112, phone 120, phone 122, phone 152, phone 155, VoIP phone 162, VoIP phone 160 and personal computer 175. Phone 105, phone 110 and phone 112 are connected to central network 125 through wireless network 165. Phones 120 and 122 are connected to wireless network 165 and to VoIP gateway 130 through remote network 170. In an example embodiment, remote network 170 is a PSTN. Phone 160 may be a VoIP phone directly connected to central network 125. Phone 157 may be connected through home gateway 152 to hybrid fiber coax (HFC) network 185 which is connected to central network 125 through cable headend 135, for example. Phone 155 may be connected to HFC network 185 through embedded multimedia cable adapter (eMTA)/enhanced digital video adapter (eDVA) 150. Phone 162 may be a VoIP phone connected to central network 125 through remote network 127. Personal computer 175 may be connected to central network 125. Personal computer 175 may be used for communications to another device, but it may also be used to configure the intelligent FM/FM service. Session processing agent 148 and presence server 145 may also be connected to central network 125. FM/FM application 195 is located on a server which may also be connected to central network 125.

In an example embodiment, devices 157 and 160 may be the only devices that have a direct association with the FM/FM service due to network logistics. However, devices 105 and 110 are also in the FM/FM group. If at time stamp zero, a call is received on device 157 and terminated at timestamp 55, then at timestamp 61 a call is originated from device 105 and terminated at timestamp 75. When, at timestamp 90, an incoming call for the FM/FM group is received, the call will be routed to device 157 since calls from 105 will not be known to the FM/FM service. However, on some devices it is possible to have a client embedded which can report when a call is originated from that device within the FM/FM service.

The FM/FM system tracks usage of the endpoints in a FM/FM group and stores the data for a time period selected by the service provider and/or user. In an example embodiment, the granularity of the time and date stored by the FM/FM system may be selected by the service provider and/or user. The endpoint contact selections methods may be combined. In an example embodiment, the FM/FM system may be notified by at least one of text messages, email, IVR, and web, among others, and may perform functions such as removing an endpoint from a FM/FM group. The removal of the endpoint may be for a specific period of time, such as the next thirty minutes, for example. In an example embodiment, an endpoint may be removed on a specific date, such that this endpoint is not contacted on July 21, for example. In an example embodiment, the endpoint may be removed on a specific day, such that this endpoint is not contacted on Sundays for example. In an example embodiment, an endpoint may be removed during specific time periods, such that this endpoint is not contacted between 4:00 pm and 8:00 pm via text, for example. In an example embodiment a user may update her presence status by one or more of notification methods. Integration with an email server for status of a user such as, out of office, in a meeting, etc. . . . may also be performed.

In an example embodiment, the ordering of the endpoints in a particular intelligent FM/FM service group may be performed using one or more methods, including but not limited to an historical method, a weighted method, a hard-coded method, and most recent use. White or black list functionality may be applied to any of the methods.

The historical method bases the order of endpoint contact on a statistical likelihood of the user being near the end point based on TOD, DOW, and/or date of year historical information. The historical method is differentiated from the most recently used method in that it can track historical patterns of use rather than sheer volume. For example, on Mondays between 2 pm and 4 pm, calls are most frequently originated or terminated on device 157. When an incoming call to the intelligent FM/FM system is received at 2:45 pm on Monday from device 162, using the historical method, the call will be sent to device 157, even if a call was originated from device 155 at 2:30 pm on Monday. However, for all other time periods outside of 2 pm to 4 pm on Monday, the most used device in the group may be device 155.

Another method of arranging the ordered list in an example embodiment of the disclosed intelligent FM/FM system is a weighted method. The weighted method bases the order of endpoint contact on a weighting value associated with an endpoint. The weighting may be user defined. The weighting may be a system applied or updated based on criteria such as, but not limited to, quantity of calls completed to or terminated at a specific endpoint, quantity of calls originated by a specific endpoint (regardless of completion status), percentage of calls completed to a specific endpoint (or terminated), and percentage of calls completed (originated and terminated) on a specific endpoint. Network preference can also be used as a criteria in the weighted system.

The intelligent FM/FM system may be contrasted with a hard coded method of selecting a particular endpoint. The hard coded method bases the order of endpoint contact on an order specified by the user. The order of contact may be impacted by the TOD, DOW and date setting specified by the user, but is not affected by tracked usage of the user.

Another method may be most recently used, which bases the order of endpoints on the last known successful contact with each endpoint in an FM/FM group. This method may use statistical data of which entities the user contacted and which entities contacted the user, and their relative contact times.

Scenario A (Call on Jan. 14, 2011, a Friday, at 11:59 am Inbound from 404-555-2222 to the FMFM #)

| | | | | Weighted | | | | | |
|---|---|---|---|---|---|---|---|---|---|
| | | | | | | % | | | |
| Historical | | | | | | Completed | % of Call | | |
| | | DOW | | QTY | QTY | to EP | Completed | | Most |
| | | & | | Completed | Originated | (Term | (Orig & | Hard | Recently |
| DOY | DOW | TOD | TOD | to EP | by EP | Only) | Term) | Coded | Used |
| N/A | N/A | N/A | 1 | 1 | 1 | 2 | 1* | 1 | 1 |
| N/A | N/A | N/A | 3 | 2* | 2* | 3 | 1* | 3 | 3 |
| N/A | N/A | N/A | 2 | 2* | 2* | 1 | 1* | 2 | 2 |

* = use some other criteria to decide since they're equal

Scenario B (Call on Jan. 19, 2011, a Wednesday, at 2:12 pm Inbound from 404-555-6262 to the FMFM #)

| | | | | Weighted | | | | | |
|---|---|---|---|---|---|---|---|---|---|
| | | | | | | % | | | |
| Historical | | | | | | Completed | % of Call | | |
| | | DOW | | QTY | QTY | to EP | Completed | | Most |
| | | & | | Completed | Originated | (Term | (Orig & | Hard | Recently |
| DOY | DOW | TOD | TOD | to EP | by EP | Only) | Term) | Coded | Used |
| N/A | N/A | N/A | 2 | 1 | 1 | 2 | 2 | 1 | 2 |
| N/A | N/A | N/A | 1 | 3 | 2* | 3 | 3 | 3 | 3 |
| N/A | N/A | N/A | 3 | 2 | 2* | 1 | 1 | 2 | 1 |

* = use some other criteria to decide since they're equal

Scenario C (Call on Feb. 1, 2011, a Tuesday, at 1:13 pm Inbound from 404-555-8282 to the FMFM #)

| | | | | Weighted | | | | | |
|---|---|---|---|---|---|---|---|---|---|
| | | | | | | % | | | |
| Historical | | | | | | Completed | % of Call | | |
| | | DOW | | QTY | QTY | to EP | Completed | | Most |
| | | & | | Completed | Originated | (Term | (Orig & | Hard | Recently |
| DOY | DOW | TOD | TOD | to EP | by EP | Only) | Term) | Coded | Used |
| N/A | 1 | 1 | 3 | 1 | 1* | 2 | 3 | 1 | 1 |
| N/A | 3 | 3 | 1 | 3 | 1* | 3 | 2 | 3 | 2 |
| N/A | 2 | 2 | 2 | 2 | 1* | 1 | 1 | 2 | 3 |

* = use some other criteria to decide since they're equal

Table 1 provides example scenarios for the ordering of devices in the intelligent FM/FM group. Table 1 comprises a list of events that occur over a number of months under different sorting algorithms. Three phones are used in this example: cell phone, home phone, and work phone. Three phones are provided in these examples, but any number of numbers may be used in the ordered list. The call order in these examples is sorted based on four non-limiting example algorithms: historical, weighted, hard coded, and most recently used. In an example historical algorithm, the calls may be ordered based on day of year (DOY), day of week (DOW), time of day (TOD), and day of week combined with time of day (DOW & TOD). In an example weighted algorithm, the call order is determined based on quantity completed to an endpoint, quantity originated by an endpoint, percentage completed to an endpoint, and percentage of calls completed (both originated and terminated). In an example hard coded algorithm, the call order is hard coded in a particular order and not adjusted by tracked usage. In a most recently used algorithm, the call order is based on the most recently used device.

Table 1 provides a number of call scenarios based on a day and time from a particular phone number. The scenario details may be processed through a call history table to generate a call order that would be used depending on which algorithm is used. If historical is used, the order is based on day of year, day of week, day of week and time of day, or time of day. In an example embodiment, when day of year is used, no matter what time of day the call is received, for instance on Mother's Day, the call is routed to a particular phone. If day of week is used, if, for example, the day is Tuesday, the call is routed to this particular phone. With DOW and TOD, if a call is received at 2:00 on a Tuesday, it is routed to a particular phone. If TOD is used and a call is received at 2:00, for example, the call is routed to a particular phone.

Scenarios A-F of Table 1 progress through a timeline of class under a number of non-limiting algorithms. In Scenario A, a call is received on Friday, Jan. 14, 2011 at 11:59 AM from 404-555-2222. If the call is processed using the historical algorithm, it may first run under day of the year and those are set as not applicable. Then the day of week, followed by the day of the week and the time of day for that particular call. As this is the first scenario being processed by the system, the call history has not processed enough data for there to be a meaningful selection for those headings. In a typical scenario, the cell phone was called. After the cell phone did not answer the call, the transmission was sent to the work phone based on when the call was historically completed successfully. Using the weighted algorithm, the quantity of completed to a particular endpoint may be used to determine the connection order. Additionally, the connection order may be dependent on the quantity originated by an endpoint, the percentage completed to an endpoint (terminated only), or the percentage of the calls completed (originated and terminated).

The hard-coded algorithm is configured to the order selected by the user. As an example, the user may, in a particular situation always connect to the cell phone first, then the work phone, and then the home phone. The most recently used algorithm updates the connection order each time a call is connected. The most recently used number is moved to the number one position. With the exception of the hard-coded algorithm, the orders are updated after activity with the numbers. Then as a call come in to the main number, the call is routed based on the algorithm being used.

Previous FM/FM systems have an application server that may contain a database of numbers that a user calls for scheduling in another static database. When a call is placed, the call is routed to the server, and the server then accesses the database to find the appropriate contact for the user. This is a relatively static method. The disclosed systems and methods of intelligent FM/FM service uses a similar network model, but updates the order of the list based on a tracking of the endpoints.

When a communication is routed through the one number service, the service can determine at which number the communication was terminated. However, for the system to track a number for a communication originated by the user, the system accesses information of the numbers in the call path to connect to those numbers. The system may monitor the numbers, including where the communication is terminated, for storage in a database. In an example embodiment, the data stored in the database may be based on the number at which the user actually answered or sent the communication as opposed to where an unsuccessful attempt was made. In proprietary network systems, the network preferably owns or has free access to the number from which the calls are originated. Alternatively, a reporting mechanism may be implemented to share data between networks.

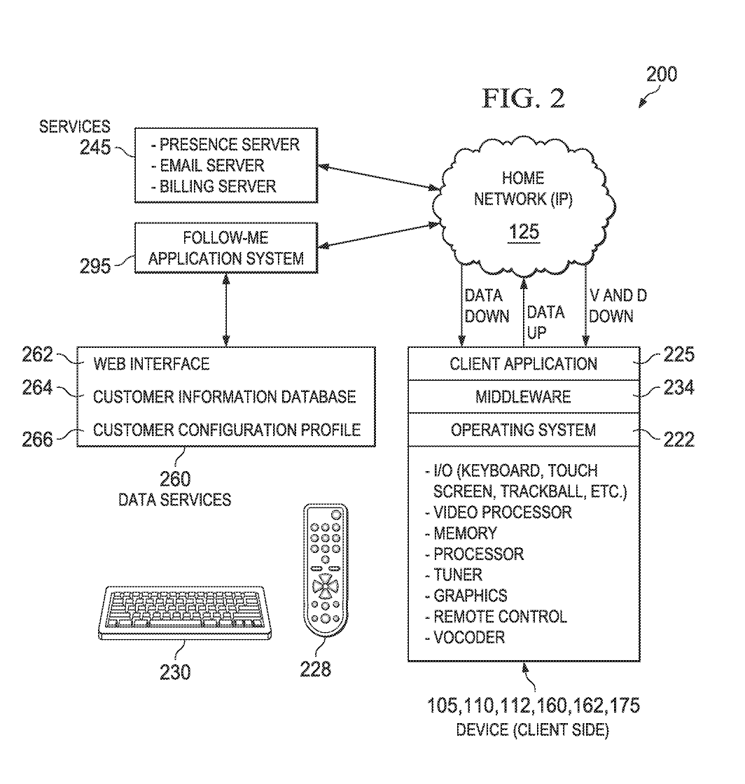

FIG. 2 provides system block diagram 200 of an example embodiment of the system interface for a device within the intelligent FM/FM system. FM/FM devices 105, 110, 112, 160, 162, and 175 receive data from and send data to central network 125. Video and data may also be transmitted from central network 125 to the client side device. A typical client side device may comprise one or more of a I/O device (keyboard, touch screen, trackball, mouse, etc.) a video processor, memory, general processor, a tuner, graphics, a remote control and a vocoder, among other system devices. Client side devices may include operating system 222, middleware 234, and client application 225. FM/FM application system 195 routes communications to client devices through central network 125. FM/FM application system accesses services 245 to update the order of the contacts in the service group for routing of communications. Services 245 may include, as non-limiting example, a presence server, an email server and a billing server. FM/FM application system may be updated by a user using a user interface such as keyboard 230 or remote control 228, for example. FM/FM application system 295 may be updated through one or more of web interface 262, customer information database 264, and customer configuration profile 266 as non-limiting examples.

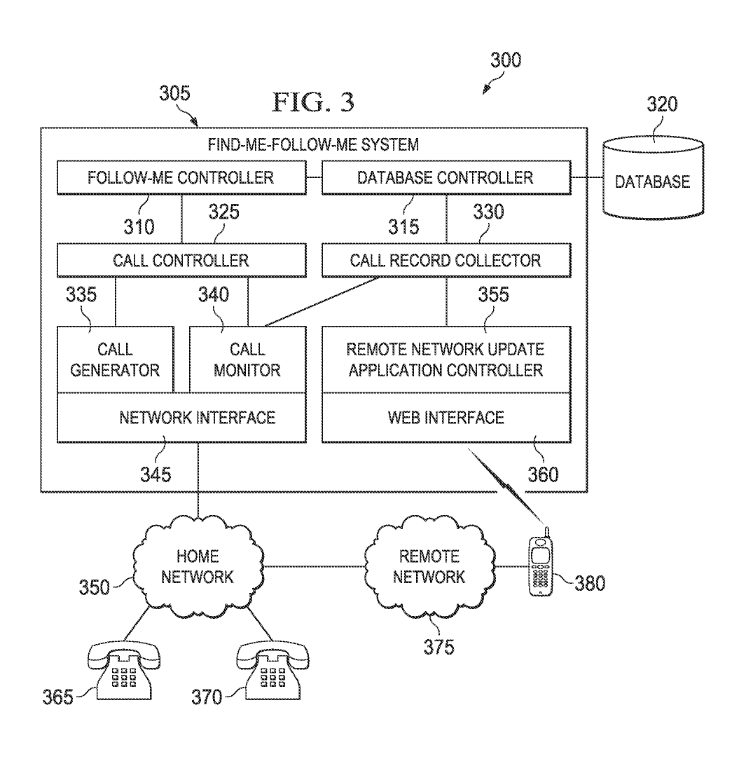

FIG. 3 provides block diagram 300 of the FM/FM system using FM/FM application 305. FM/FM application 305 comprises several logical elements which work together to provide the follow me functionality. In an example embodiment, these logical elements include one or more of follow me controller 310, database controller 315, call controller 325, call record collector 330, call generator 335, call monitor 340, network interface 345, remote network update controller 355, and web interface 360.

In an example embodiment, network interface 345 is an abstraction layer used to control the network signaling. The network interface provides access to home network 345. Home network 345 may use various signaling protocol such as SIP or AIN as non-limiting examples. These protocols are used in call signaling and allow the application to initiate, terminate, and proxy call sessions. Network interface 345 typically provides an application programming interface (API) to be leveraged by the application logic.

In an example embodiment, web Interface 360 is an abstraction layer used to enable the application to receive and initiate hypertext transfer protocol (http) sessions. Web interface 360 allows for a layer of abstraction between the underlying protocol, such as http and https. Web interface 360 typically provides an API to be leveraged by the application logic. In an example embodiment, database controller 315 provides an abstraction layer between the application logic and database 320. Database controller 315 may provide a standard API for managing data on database 320.

In an example embodiment, call generator 335 sets up and handles calls to the follow me endpoints. Call generator 335 manages the call states using the API of network interface 345. Call generator 335 only contains logic to establish and maintain calls. In an example embodiment, call generator 335 is controlled by call controller 325. In an example embodiment, call monitor 340 informs the application of call traffic within central network 350. Call monitor 340 uses the API of network interface 345 to monitor central network 350. When a call is received call monitor 340 invokes listeners in call controller 325 and call record collector 330 and sends both modules the call details.

In an example embodiment, call controller 325 manages both call generator 335 and call monitor 340. Call controller 325 is used as an abstraction layer. Call controller 325 handles higher level call control and coordination. Example functionality includes forking and sequencing calls depending on the follow me logic provided by follow me controller 310′. Upon receiving a call call controller 325 may request a list of follow me endpoints and the order they should be contacted from the follow me controller. If two or more endpoints have the same order they may be contacted simultaneously.

In an example embodiment, remote network update controller 355 provides a means for an application on remote network 375 to updated call statistics. Remote network update controller 355 may use the API of web interface 360 to enable an update web service. The web service may collect the call information and invoke a listener in call record collector 330. Call record collector 330 places call records uniformly in database 320. Call record collector 330 takes inputs from both call monitor 340 and remote network update controller 355.

In an example embodiment, follow me controller 310 contains the main application logic. The application logic is triggered when call controller 325 requests a list of follow me endpoints and the order that they should be contacted. Follow me controller 310 then retrieves the data from database controller 315 related to the incoming call. Then, depending on the desired follow me logic (as described separately), the follow me endpoints are selected and ordered. This list is then returned to call controller 325.

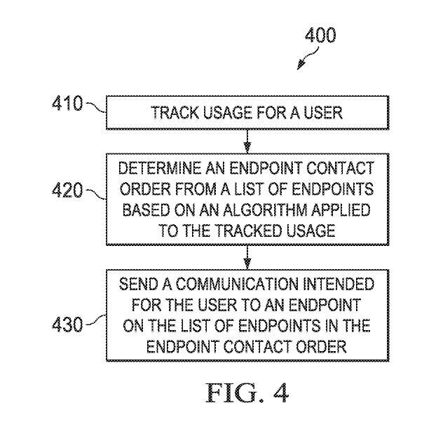

FIG. 4 provides a flow diagram of an example embodiment of a method of providing intelligent find me follow me services. In block 410, usage for a user is tracked. In block 420, an endpoint contact order from a list of endpoints is determined based on an algorithm applied to the tracked usage. In block 430, a communication intended for a user is sent to an endpoint in the list of endpoints in the endpoint contact order.

In an example embodiment, a service provider offers the FM/FM service. The service provider owns the network and the endpoints so the system can keep track of when each of those endpoints places a call. The call may be mapped for/by the service provider. If one of the endpoints is owned by a different system, the service provider may not have visibility into that endpoint. A reporting system from that un-owned endpoint may provide that visibility. In an example embodiment, the intelligent FM/FM application resides on a central server. Whether the central server is a single server or a network of servers, it may be considered as one logical piece. A signal element connects to a voice network via a signaling protocol such as Session Initiation Protocol (SIP), Integrated Service Digital Network user part (ISUP), or some other signaling protocol. In an example embodiment, a database and a web server (with a web interface, for example) send data for calls to endpoints that are not owned by the resident network.

In an example embodiment, the application comprises a logic section that determines the endpoint when a call is received. The application may perform a database look up, pull statistical data and process the data based on a particular algorithm. Non-limiting example algorithms may be based on the last place known to have been connected and the percentage of the calls that go to a particular endpoint, among others. A presence server may determine a user status, what systems the user is using, or even the physical location of the user. The presence server may be IP-based. The presence server may interface with the central network. A web-interface may be provided to a user for control of the algorithm among other aspects. Alternatively, a client application may be present on user devices to push information back to the system. An information database may be available to the application system, which may provide access to a customer configuration profile.

In an example embodiment, an email server is used to collect non-call data such as presence to determine if a device should be contacted. For instance, if a user has her out-of-office notification set up in her email client, sending a call to the office device is not useful. So presence data may be obtained from sources other than phone servers. Presence data may also be provided, for example, by a billing server when a user turns off service because she will be going to be out of town. In an example embodiment, a service provider network has both a telecommunications network and an IP network included within it.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
tracking usage for a user;
determining an endpoint contact order from a list of endpoints based on an algorithm applied to the tracked usage; and
sending a communication intended for the user to an endpoint on the list of endpoints in the endpoint contact order.

2. The method of claim 1, wherein the algorithm comprises at least one of an historical method, and a weighted method.

3. The method of claim 2, wherein the historical method bases the endpoint contact order on a statistical likelihood of the user being near the endpoint on at least one of the time of day, the day of week, and the date of year from the tracked usage.

4. The method of claim 2, wherein the weighted method bases the endpoint contact order on a weighted value associated with the endpoint and the tracked usage.

5. The method of claim 4, wherein the weighted method assigns weights to the endpoints by at least one of:
based on network preference; and
based on at least one of:
quantity of calls completed to a specific endpoint;
percentage of calls completed to a specific endpoint; and
percentage of calls completed on a specific endpoint.

6. The method of claim 1, further comprising receiving data regarding usage for the user, the data received from a foreign network.

7. The method of claim 1, wherein the endpoint contact order is set by time of day, day of week, and date of year setting set by the user.

8. A system for directing communication comprising:
a presence server configured to track usage for a user;
an application server configured to determine an endpoint contact order for a list of endpoints based on an algorithm applied to the tracked usage; and
a network configured to send a communication to an endpoint on the list of endpoints in the endpoint contact order.

9. The system of claim 8, wherein the application server determines the endpoint contact order by applying at least one of an historical algorithm, and a weighted algorithm.

10. The system of claim 9, wherein the historical algorithm sets the endpoint contact order based on a statistical likelihood of the user being near the endpoint on at least one of the time of day, the day of week, and the date of year from the tracked usage.

11. The system of claim 9, wherein the weighted algorithm sets the endpoint contact order based on a weighted value associated with the endpoint and the tracked usage.

12. The system of claim 11, wherein the weighted algorithm assigns weights to the endpoints by at least one of:
based on network preference; and
based on at least one of:
quantity of calls completed to a specific endpoint;
percentage of calls completed to a specific endpoint; and
percentage of calls completed on a specific endpoint.

13. The system of claim 9, wherein data regarding usage for the user is received from a foreign network.

14. The system of claim 8, wherein the endpoint contact order is set by time of day, day of week, and date of year setting set by the user.

15. A computer readable medium comprising a computer program comprising instruction for:
tracking usage for a user;
determining an endpoint contact order from a list of endpoints based on an algorithm applied to the tracked usage; and
sending a communication intended for the user to an endpoint on the list of endpoints in the endpoint contact order.

16. The computer readable medium of claim 15, wherein the algorithm comprises at least one of an historical method, and a weighted method.

17. The computer readable medium of claim 16, wherein the historical method bases the endpoint contact order on a statistical likelihood of the user being near the endpoint on at least one of the time of day, the day of week, and the date of year from the tracked usage.

18. The computer readable medium of claim 16, wherein the weighted method bases the endpoint contact order on a weighted value associated with the endpoint and the tracked usage.

19. The computer readable medium of claim 18, wherein the weighted method assigns weights to the endpoints by at least one of:
based on network preference; and
based on at least one of:
quantity of calls completed to a specific endpoint;
percentage of calls completed to a specific endpoint; and
percentage of calls completed on a specific endpoint.

20. The computer readable medium of claim 16, further comprising instructions for receiving data regarding usage for the user, the data received from a foreign network.
